(19) United States
(12) Patent Application Publication
(10) Pub. No.: US 2013/0191728 A1
(43) Pub. Date: Jul. 25, 2013

(54) SYSTEMS, METHODS, AND MEDIA FOR GENERATING ELECTRONIC BOOKS

(71) Applicants: Steven Victor McKinney, Ross, CA (US); Ron Severdia, San Anselmo, CA (US)

(72) Inventors: Steven Victor McKinney, Ross, CA (US); Ron Severdia, San Anselmo, CA (US)

(21) Appl. No.: 13/355,451

(22) Filed: Jan. 20, 2012

(51) Int. Cl. G06F 17/00

(52) U.S. Cl. 715/243

(57) ABSTRACT

Systems, methods, and media for generating electronic books are provided herein. Methods may include obtaining digital source content, the digital source content being arranged in a native format, the native format determining how the digital source content is displayed on a user interface, and determining characteristics from the digital source content, the characteristics at least defining a layout of the digital source content in the native format; and rendering the determined content into an electronic book according to an electronic book standard, based upon the characteristics such that a generated format of the electronic book substantially corresponds to the native format of the digital source content.

### FIELD OF THE TECHNOLOGY

Embodiments of the disclosure relate to the generation of electronic books. Systems, methods, and media provided herein may be utilized to generate electronic books from various types of digital source content. The electronic books may be generated according to a plurality of electronic book standards. The present technology may also allow for the inclusion of assets, such as interactive objects, within an electronic book and also for conversions of electronic books rendered according to a first electronic book standard into one or more electronic books according to different electronic book standards.

### BACKGROUND OF THE DISCLOSURE

Current methods for generating electronic books from digital source content may produce undesirably formatted electronic books. For example, digital source content such as a document stored in a word processing program file, when converted into an electronic book according to an electronic book standard such as ePub, results in the generation of an electronic book that does not retain the native format of the digital source content. That is, a view of the electronic book when displayed on a display device may not resemble a view of the digital source content when the digital source content is rendered by an appropriate program (e.g., a program designed to display the content). These errors may arise from discrepancies in conversion of the digital source content according to the electronic book standard. Also, conversion between different electronic book standards remains problematic.

### SUMMARY OF THE DISCLOSURE

According to some embodiments, the present technology may be directed to methods for generating an electronic book according to an electronic book standard by: (a) obtaining digital source content, the digital source content being arranged in a native format, the native format determining how the digital source content is displayed on a user interface; and (b) determining characteristics from the digital source content, the characteristics at least defining a layout of the digital source content in the native format; and (c) rendering the determined content into an electronic book according to an electronic book standard, based upon the characteristics such that a generated format of the electronic book substantially corresponds to the native format of the digital source content.

According to other embodiments, the present technology may be directed to methods for transforming a first electronic book that was generated according to a first electronic book standard into a second electronic book generated according to a second electronic book standard. The methods may include: (a) determining characteristics from content of the first electronic book, the characteristics at least defining a layout of the content that defines how the content of the first electronic book is displayed; and (b) transforming content into the second electronic book according to the second electronic book standard in such a way that when the content of the second electronic book is displayed, the display of the content of the second electronic book is substantially similar to the display of the content of the first electronic book.

According to additional embodiments, the present technology may be directed to systems for generating an electronic book according to the electronic book standard. The systems may comprise: (a) a memory for storing executable instructions; (b) a processor for executing the instructions stored in memory; (c) an input module stored in memory and executable by the processor to obtain digital source content, the digital source content being arranged in a native format, the native format determining how the digital source content is displayed on a user interface; (b) a parse module stored in memory and executable by the processor to determine characteristics from the digital source content, the characteristics at least defining the layout of the digital source content in the native format; and (c) a rendering engine stored in memory and executable by the processor to render the determined content into an electronic book according to the electronic book standard, based upon the characteristics such that a generated format of the electronic book substantially corresponds to the native format of the digital source content.

According to some embodiments, the present technology may be directed to systems for editing an electronic book being generated according to an electronic book standard. The systems may include: (a) a memory for storing executable instructions; (b) a processor for executing the instructions stored in memory; (c) an editing module stored in memory and executable by the processor to manage assets for the electronic book, the assets being included in the electronic book according to the electronic book standard; and (d) wherein an asset includes one or more attributes and the asset is inserted into the electronic book by the editing module according to the electronic book standard and the one or more attributes.

According to other embodiments, the present technology may be directed to computer readable storage media that includes instructions for generating an electronic book according to an electronic book standard by: (a) obtaining digital source content, the digital source content being arranged in a native format, the native format determining how the digital source content is displayed on a user interface; and (b) determining characteristics from the digital source content, the characteristics at least defining a layout of the digital source content in the native format; and (c) rendering the determined content into an electronic book according to an electronic book standard, based upon the characteristics such that a generated format of the electronic book substantially corresponds to the native format of the digital source content.

### BRIEF DESCRIPTION OF THE DRAWINGS

The accompanying drawings, where like reference numerals refer to identical or functionally similar elements throughout the separate views, together with the detailed description below, are incorporated in and form part of the specification, and serve to further illustrate embodiments of concepts that include the claimed disclosure, and explain various principles and advantages of those embodiments.

The methods and systems disclosed herein have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

FIG. 1 illustrates an exemplary system for practicing aspects of the present technology;

FIG. 2 illustrates an exemplary conversion application for generating electronic books;

FIG. 3A-H illustrate exemplary user interfaces that allow end users to determine how digital source content is converted into an electronic book;

FIGS. 3I and 3J illustrate exemplary user interfaces that allow end users to edit the content of an electronic book, such as inserting rich features;

FIG. 4 illustrates an exemplary user interface, such as a book manager page;

FIG. 5 illustrates an exemplary user interface, such as a client manager page;

FIG. 6 illustrates a plurality of current page option panels that may be utilized by end users to edit pages of their electronic books;

FIG. 7 illustrates a plurality of links option panels that may be utilized by end users to edit links included in pages of their electronic books;

FIG. 8 illustrates a plurality of media option panels that may be utilized by end users to edit media included in pages of their electronic books;

FIG. 9 illustrates a plurality of book option panels that may be utilized by end users to edit book characteristics of their electronic books;

FIG. 10 illustrates a pair of information panels that display assets that are currently in use or linked by a particular page, along with publication details and special notes associated with the page and/or the electronic book with which the page is associated;

FIG. 11 is a flowchart of an exemplary method for generating an electronic book according to an electronic book standard; and

FIG. 12 illustrates an exemplary computing system that may be used to implement embodiments according to the present technology.

### DETAILED DESCRIPTION

In the following description, for purposes of explanation, numerous specific details are set forth in order to provide a thorough understanding of the disclosure. It will be apparent, however, to one skilled in the art, that the disclosure may be practiced without these specific details. In other instances, structures and devices are shown at block diagram form only in order to avoid obscuring the disclosure.

Generally speaking, the present technology is directed to generating electronic books according to various electronic book standards. More specifically, the present technology may convert documents in non-electronic book formats into electronic books. These source documents are hereinafter referred to as “digital source documents.” For example, the present technology may convert image files, XML files, portable document files (PDF), and word processing files, Adobe InDesign™, and Quark™ into electronic books according to one or more electronic book standards. While the above-described file types have been provided for explicating exemplary document formats that may be converted into electronic books by the present technology, one of ordinary skill in the art will appreciate that many other non-electronic book format files may likewise be utilized in accordance with the present disclosure.

Broadly described, the present technology may convert the digital source content into one or more electronic books in such a way that the native format of the digital source content is preserved. Each of the electronic books may include a particular electronic book standard. Exemplary, but non-limiting examples of electronic book standards (also referred to as a book type) include electronic publication (ePub) versions, Kindle™ Format 8 (KF8), iBooks™, along with other electronic book standards that would be known to one of ordinary skill in the art with the present disclosure before them.

In some applications, the present technology may parse the digital source content and extract assets therefrom. Assets may include text, images, frames, and other objects that are commonly utilized in digital document files. Additionally, the layout of the pages of the content may also be determined and/or extracted. It will be understood that the layout may include the positioning of assets within a page of the digital source content. Additionally, it will be further understood that the term “page” may be understood to include not only a typical page format or layout as would be understood relative to a physical book page, but may also include different subsets, segments, or sections of content from a document. Additionally, in some instances the term “page” may be understood relative to a visual representation of an electronic book that is being rendered. For example, if the electronic book was generated in a flowable layout/format, a “page” may include the viewable section of the document that is currently being rendered and displayed. As the electronic book is scrolled through, the “page” or view of the document changes. Moreover, it is noteworthy that the view that is rendered may not necessarily resemble the standard page format of a book. Stated otherwise, a view may include several sections of different pages (which in this instance may in fact refer to the physical pages of a book) of a book. Alternatively, the view may include a continuous flowing page with dynamically changing content.

Layout data or other metadata about the file (e.g., versioning information, creation/modification dates, author information, etc.) may also be stored in a storage media such as a database.

The present technology may automatically determine a suitable electronic book standard that is compatible with the digital source content, along with identifying conflicts between the digital source content and one or more electronic book standards. If conflicts are determined, the present technology may communicate conflict messages to an end user that inform the user of the conflict. In other instances, the present technology may automatically adjust attributes of digital source content assets to ensure that they are compatible with the electronic book standard. For example, an image extracted from the digital source content may have a size that is unacceptably large for a particular electronic book standard. The image may be automatically resized to comply with the requirements of the electronic book standard.

The present technology may render an editable view of the electronic book within an editing user interface. End users may view, insert, delete, or otherwise modify the electronic book via the editing user interface. The editing interface may include a plurality of tools that allow the electronic book to be modified. During conversion between digital source content and electronic book, views may be generated of the electronic book that allows end users to visualize the conversion process. Thus, when an end user makes a modification to the electronic book, a view of the book (or even of a page) may be rendered such that the end user can visualize the modification.

Additionally, editors may insert, modify, and/or remove rich content from an electronic book. Examples of rich content include, interactive objects such as pop-up windows, navigation menus, table of contents, bibliographies, videos, audio files, three dimensional simulations, animations, links, quizzes, tests, puzzles, social media feeds, micro-blogging content, learning management systems functionalities, multilingual translations, choose your own adventure applications, dictionaries, telephonic or other communicative interfaces, slideshows, along with any other rich features that would be known to one of ordinary skill in the art.

In some instances, the present technology may generate electronic books by converting between electronic book standards. That is, a first electronic book generated according to a first electronic book standard may be converted by the present technology into a second electronic book that is generated according to a second electronic book standard. Automatic detection and correction may also be implemented in these scenarios.

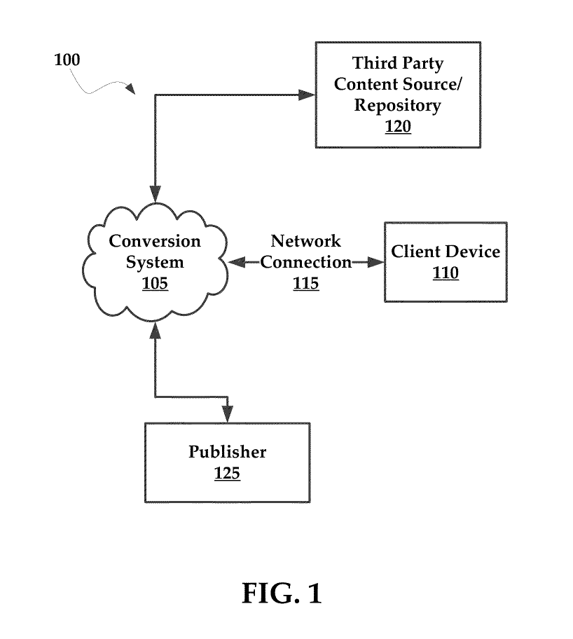

These and other advantages of the present technology will be described in greater detail with reference to the collective FIGS. 1-12.

FIG. 1 illustrates an exemplary system 100 for practicing aspects of the present technology. The system 100 may include a conversion system 105 that may be implemented in a cloud-based computing environment. A cloud-based computing environment is a resource that typically combines the computational power of a large grouping of processors and/or that combines the storage capacity of a large grouping of computer memories or storage devices. For example, systems that provide a cloud resource may be utilized exclusively by their owners; or such systems may be accessible to outside users who deploy applications within the computing infrastructure to obtain the benefit of large computational or storage resources.

The cloud may be formed, for example, by a network of web servers, with each web server (or at least a plurality thereof) providing processor and/or storage resources. These servers may manage workloads provided by multiple users (e.g., cloud resource customers or other users). Typically, each user places workload demands upon the cloud that vary in real-time, sometimes dramatically. The nature and extent of these variations typically depend on the type of business associated with the user.

In other embodiments, the conversion system 105 may include a distributed group of computing devices such as web servers that do not share computing resources or workload. Additionally, the conversion system 105 may include a single computing system that has been provisioned with a plurality of programs that each produces instances of event data.

End users may access and interact with the conversion system 105 via the client device 110 via a web-based interface, as will be discussed in greater detail infra. The conversion system 105 may communicatively couple with a client device 110 via a network connection 115. The network connection 115 may include any one of a number of private and public communications mediums such as the Internet.

Additionally, the conversion system 105 may obtain assets or other content such as images, videos, games, quizzes, and so forth, from one or more third party content sources, such as third party content source 120. In some embodiments, the conversion system 105 may also publish or transmit electronic books to various third party distributors or publishers, such as a publisher 125. It will be understood that in some instances, the electronic books generated by the conversion system 105 may be exported to, or stored in a storage media such as a content repository.

The conversion system 105 may be generally described as a mechanism for converting files that are not in an electronic book format (e.g., ePub) into electronic books, according to an electronic book standard.

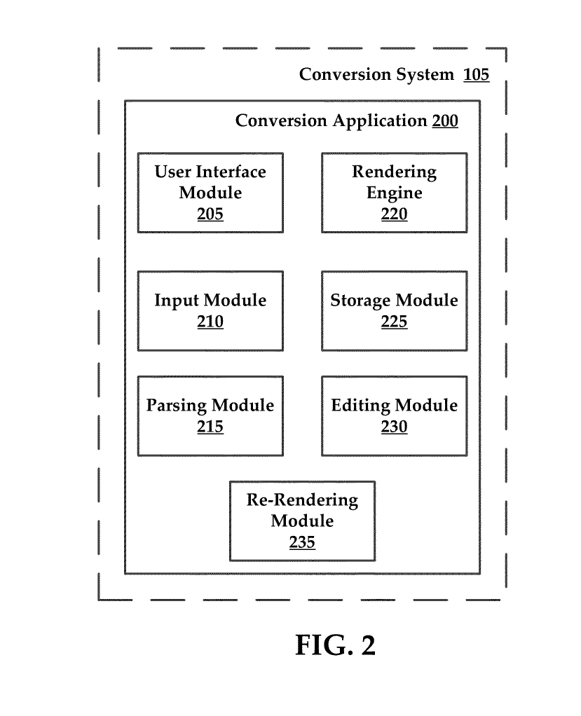

Additionally, the system 105 may provide web-based interfaces that allow end users to edit the content of an electronic book and/or or convert an electronic book from a first electronic book standard into another electronic book according to another electronic book standard. The system 105 is provided with a conversion application 200 that will be described in greater detail with reference to FIG. 2.

FIG. 2 illustrates a conversion application, hereinafter referred to as application 200. The application 200 may be generally described as being configured to obtain digital source content. The digital source content may be arranged in a native format, where the native format determines how the digital source content is displayed on a user interface. Additionally, the application 200 may be further configured to determine characteristics from the digital source content, where the characteristics at least defining a layout of the digital source content in the native format. Also, the application 200 may be further configured to render the determined content into an electronic book according to an electronic book standard, based upon the characteristics such that a generated format of the electronic book substantially corresponds to the native format of the digital source content.

According to some embodiment, the application 200 may generally include a user interface module 205, an input module 210, a parsing module 215, a rendering engine 220, a storage module 225, an editing module 230, and a re-rendering module 235. It is noteworthy that the application 200 may include additional modules, engines, or components, and still fall within the scope of the present technology. As used herein, the term “module” may also refer to any of an application-specific integrated circuit (“ASIC”), an electronic circuit, a processor (shared, dedicated, or group) that executes one or more software or firmware programs, a combinational logic circuit, and/or other suitable components that provide the described functionality. In other embodiments, individual modules of the application 200 may include separately configured web servers. Also, the application 200 may be provisioned with a cloud.

Generally described, the application 200 allows end users to input digital source content, manage the imported content, convert the digital source content into an electronic book according to an electronic book standard, and validate the conversion.

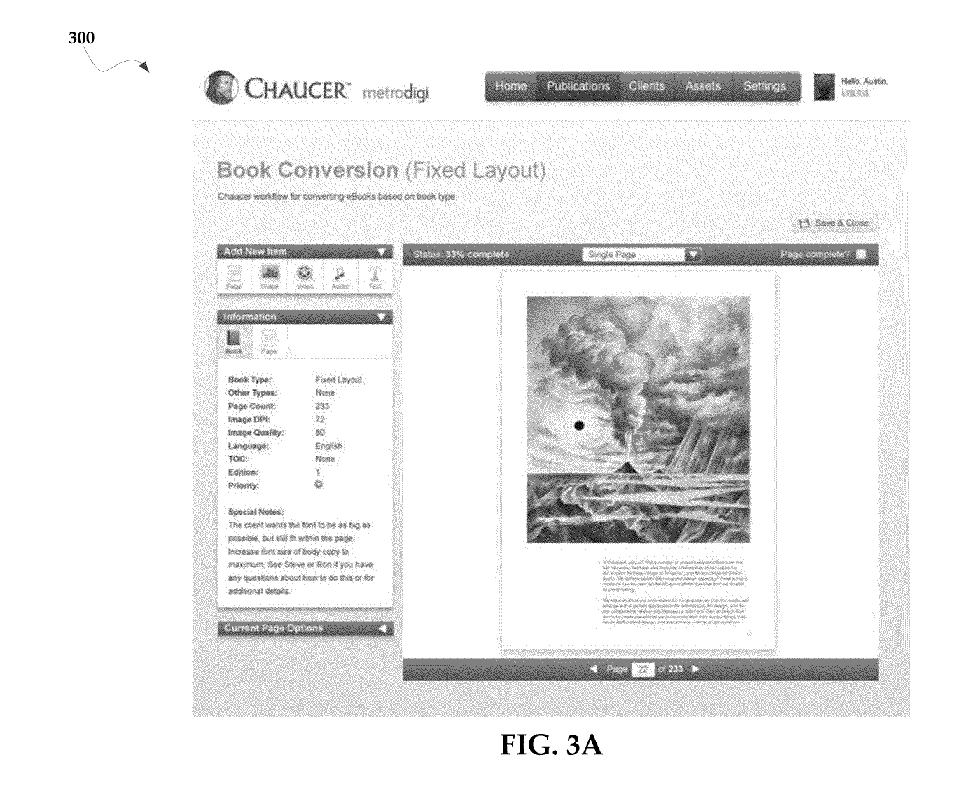

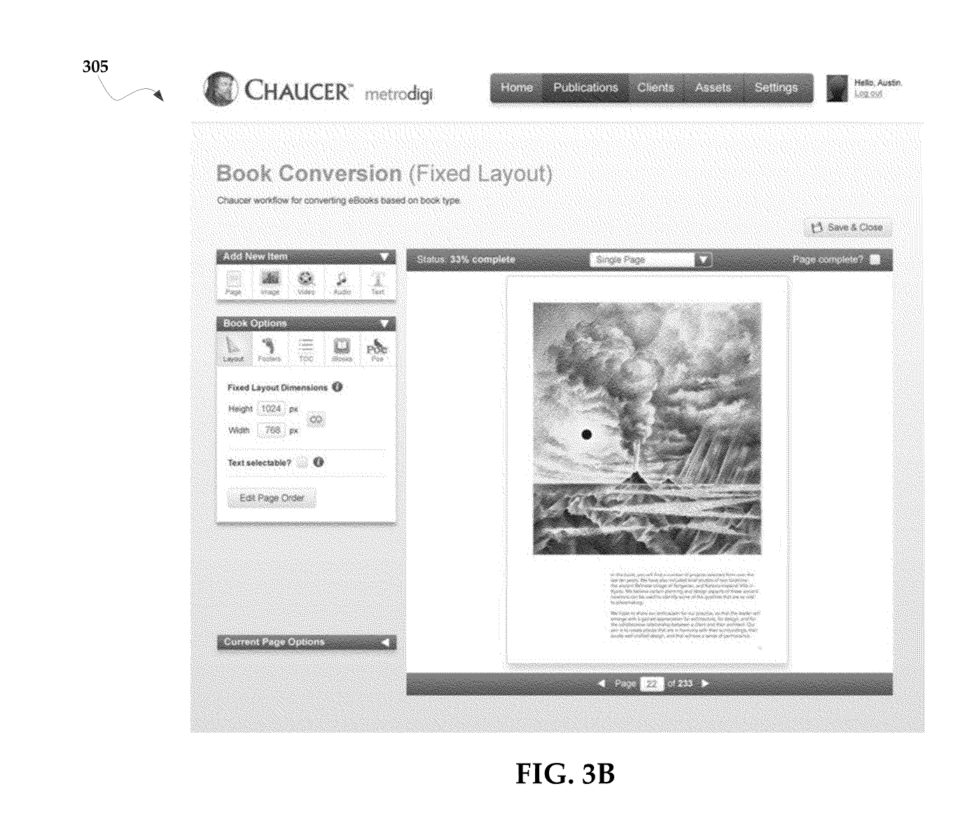

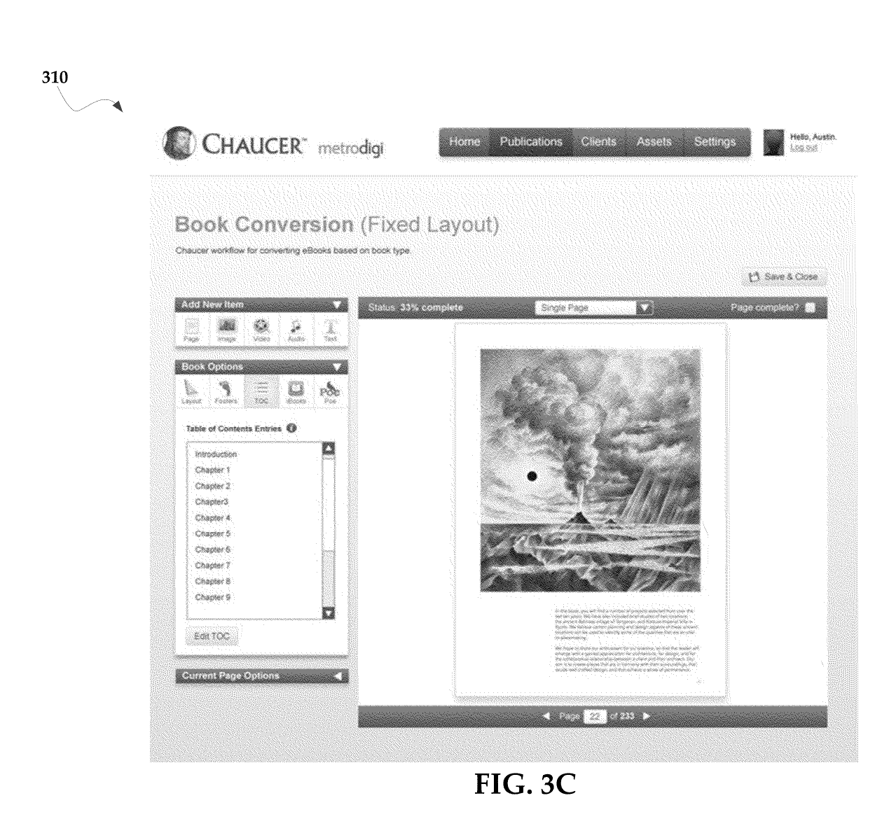

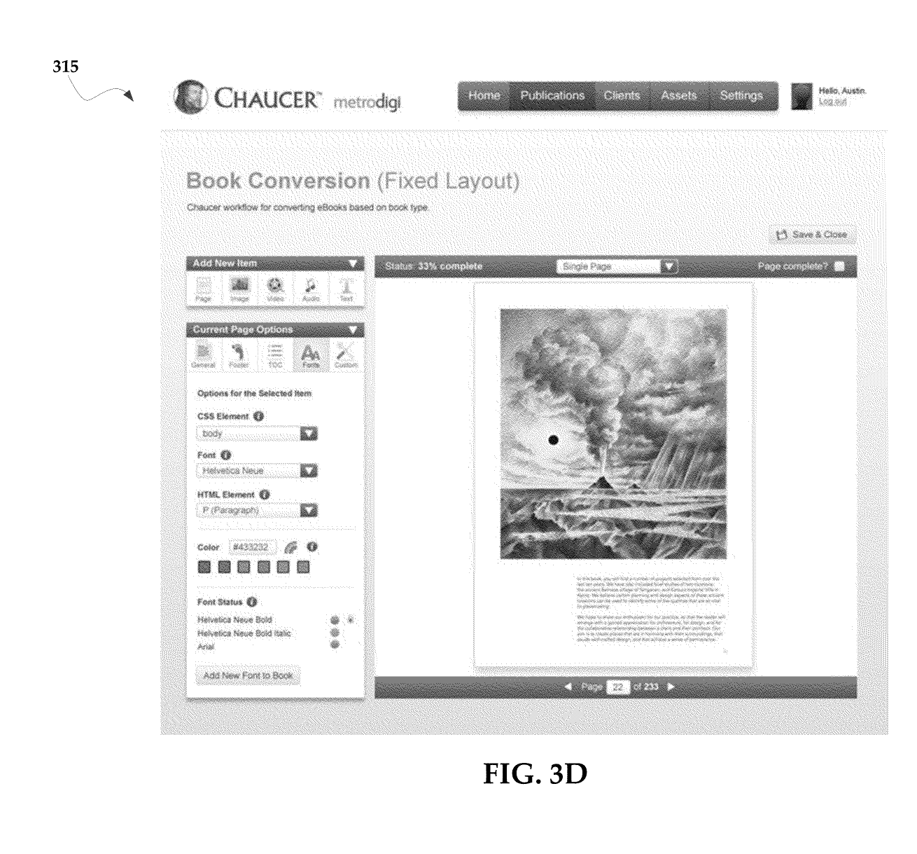

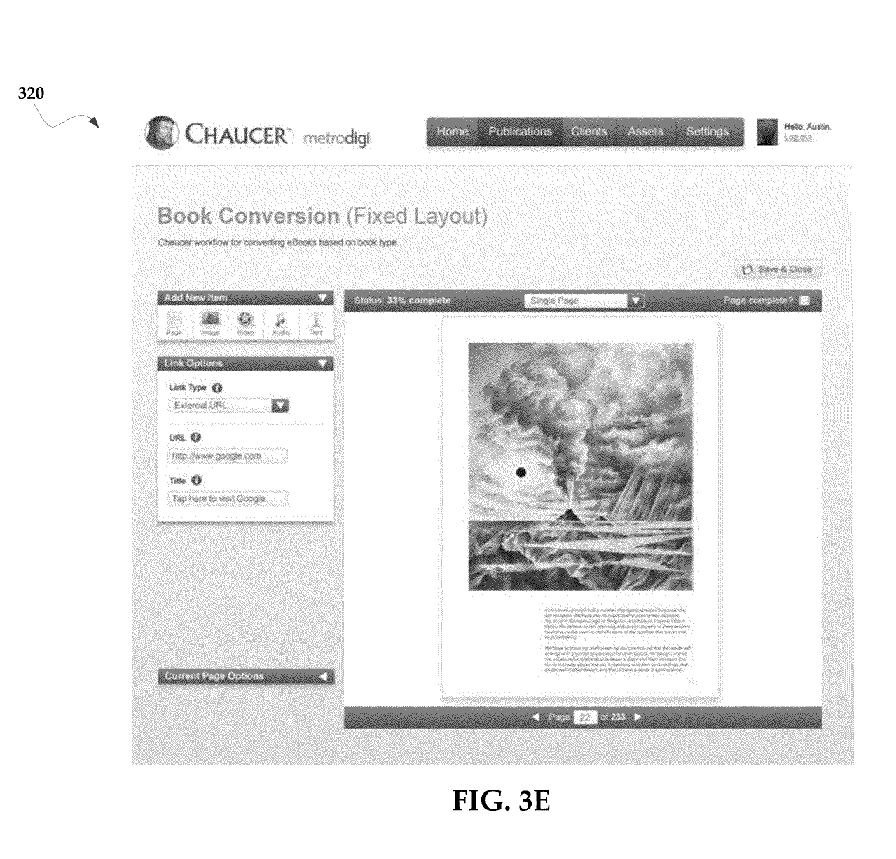

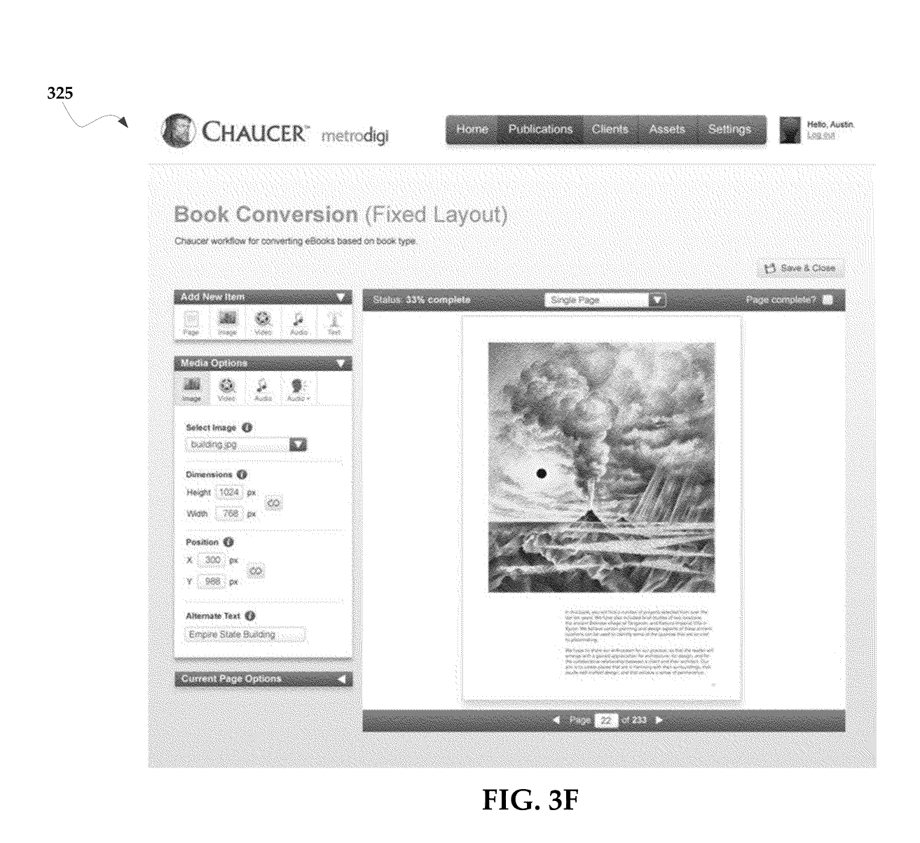

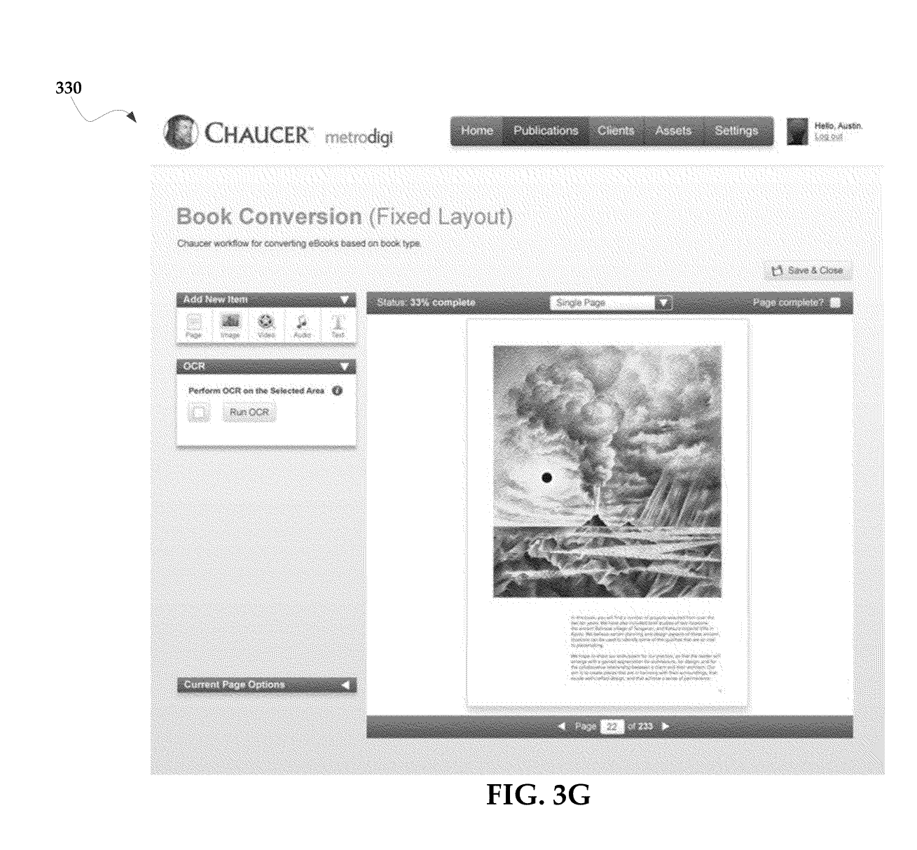

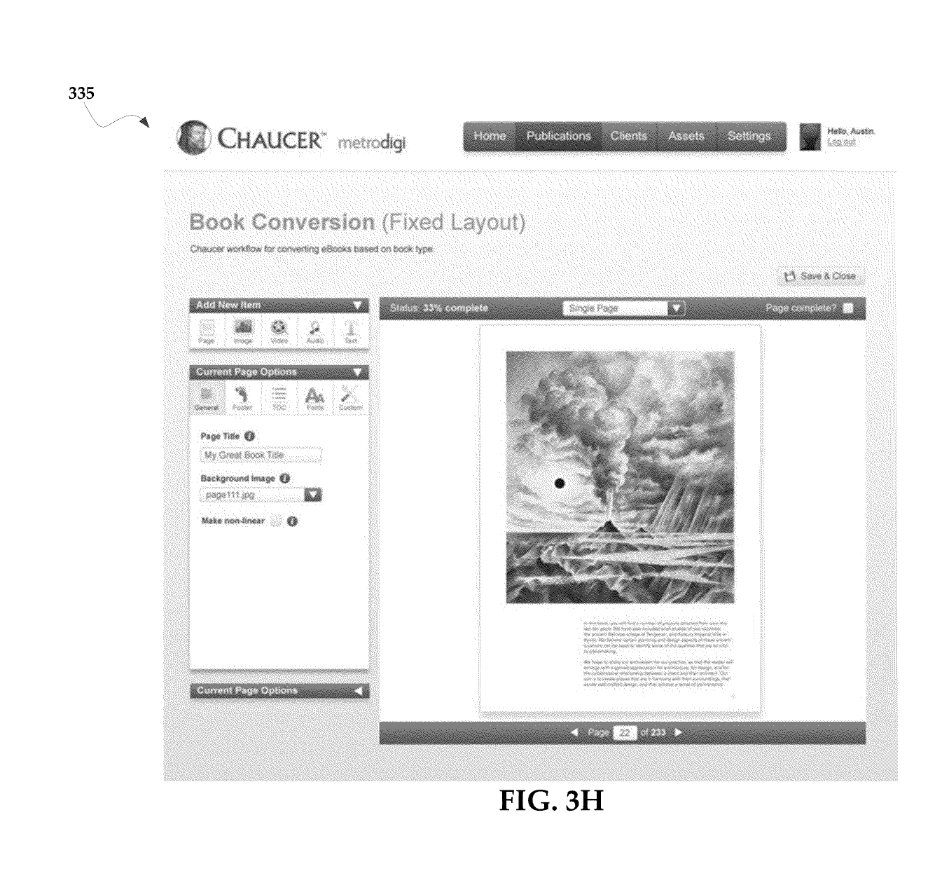

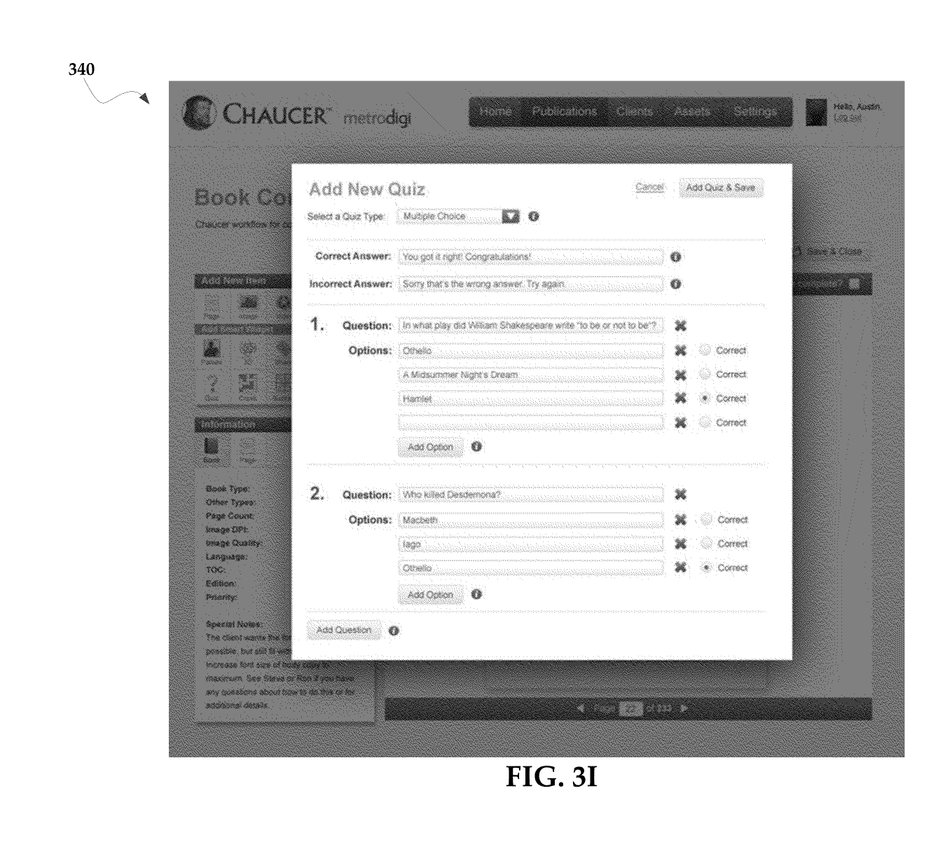

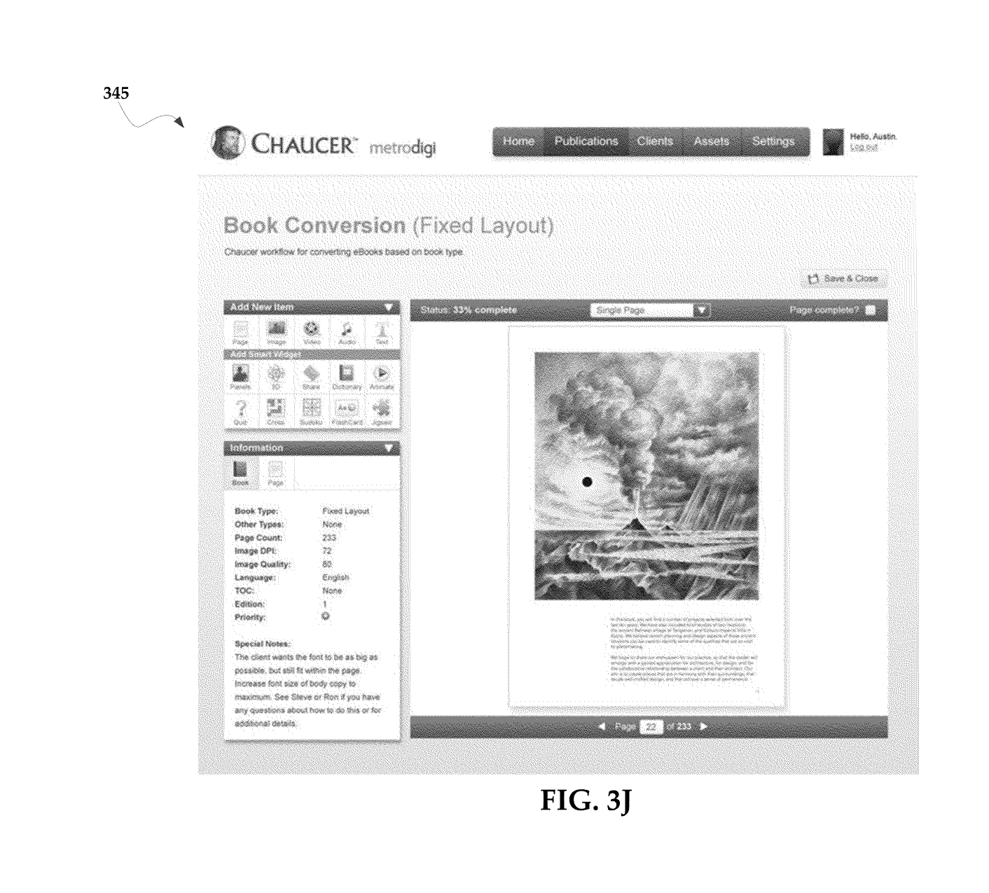

An end user may interact with the application 200 via a graphical user interface that is provisioned as a web-based interface. The web-based interface(s) may be generated by the user interface module 205. It will be understood that the user interface module 205 may generate a plurality of different graphical user interfaces that allow end users (e.g., content authors, editors, artisans, etc.) to access, view, edit, or otherwise interact with digital source content and electronic books generated according to various standards. Examples of graphical user interfaces that are generated by the user interface module 205 are provided in FIGS. 3H-10, which will all be described in greater detail infra.

End users may upload digital source content to the application 200 via a user interface. In some instances, end users may import files such as image files (e.g., Joint Photographic Experts Group (JPEG), Tagged Image File Format (TIFF), and so forth) where the pages of a document are individual images, Adobe™ InDesign Extensible Markup Language (XML) files, Portable Document Files (PDF), various word processing document files (e.g., text, rich text format, Word™, etc.), and other electronic document file formats that would be known to one of ordinary skill in the art.

The digital source content may be understood has having a native format. The native format of the digital source content refers to a visual representation of the content that is produced when a view of the digital source content is rendered. It is noteworthy, native format not only refers to the visual representation of the content, but also the structure of the data included in the digital source content files that determines the layout of assets or other content included in the digital source content files. For example, a native format for a PDF document may include a view of a page of the PDF document that is generate by a PDF viewing program. The present technology may preserve the visual appearance of the digital source content when it is converted into an electronic book. In other embodiments, end users may be allowed to edit the visual appearance of the electronic book such that the generated format of the electronic book is similar to the native format for the digital source content, but may include differences such as embellishments or modifications.

Regardless of the methodology for providing digital source content to the application, once the digital source content has been received by the application 200, the input module 210 obtains the digital source content gathered from input received via one or more user interfaces. The term “obtain” may be understood to include receive, gather, locate, download, pull, or other similar actions. It will be understood that in some instances the input module 210 may receive digital source content via another method than via a user interface, such as uploading via file transfer protocol (FTP).

The digital source content received by the input module 210 may be provided to the parsing module 215 that determines characteristics from the digital source content. The term “determine” may include evaluate, parse, extract, examine, and so forth. The characteristics of the digital source content may include at least defining a layout of the digital source content in a native format. That is, the parsing module 215 may examine the digital source content to determine the content/assets/objects included in the digital source content, such as text, images, headers, footers, and so forth. Not only does the parsing module 215 determine the assets, but the parsing module 215 may also determine attributes of the assets. For example, an asset such as an image may have attributes such as size, contrast, transparency, and so forth. In addition, the parsing module 215 may also determine the layout of the digital source content as well. More specifically, the parsing module 215 may determine the position assets on a page of a document with reference to a two viable coordinate system (e.g. Cartesian) that defines vertical and horizontal placement of the assets relative to the dimensions of the page.

In some embodiments, the parsing module 215 may also gather metadata associated not only with the digital source content itself (e.g., ISBN, description, subject codes, price, publication, date, language, etc.), but also metadata associated with individual assets included on each page of the digital source content.

Once the characteristics for the digital source content have been determined by the parsing module 215, at least a portion of the characteristics may be stored in a storage media by way of the storage module 225.

Once the parsing module 215 has parsed the digital source content, the rendering engine 220 may be executed to convert the extracted content obtained from the digital source content into an electronic book according to an electronic book standard.

In some instances the end user may select the type of electronic book that they would like to be rendered. In other instances the rendering engine 220 may automatically determine the type of electronic book that is generated by comparing the extracted information obtained from the digital source content to one or more electronic book standards. More specifically, in some instances the characteristics of the digital source content are compared to an electronic book standard, while in additional embodiments, attributes of assets may be compared to the electronic book standard. The electronic book standard that most closely corresponds to the characteristics or attributes of the digital source content may be selected (e.g., the standard having the fewest number of conflicts relative to the assets of the determined content).

Once one or more electronic book standards have been selected, the rendering engine 220 may generate a publication shell that includes all the files and layout information necessary to assemble an electronic book. For example, the rendering engine 220 may create a XML (or XHTML) file that references the locations of assets within the electronic book. The XML file may contain all of the characteristics and asset attributes for the electronic book. In other embodiments, a cascading style sheet (CSS) is created from the publication shell. In some instances, the CSS may include the layout and design for the electronic book. Additional, device-specific files may be obtained or generated that utilized the aforementioned files to render a view of the electronic book on a display device. These device-specific files may include proprietary or specifically tailored files that are readable by a particular type of display device.

Next, the rendering engine 220 may render a view of at least a portion of the electronic book that is displayed via a user interface. As mentioned previously, the generated format of the electronic book may substantially correspond to the native format of the digital source content, such that when views of the electronic book are generated they substantially correspond to view of the digital source content. That is, the rendering engine 220 may maintain consistency between the visual appearance of the digital source content and the electronic book.

According to other embodiments, the editing module 230 may be executed to receive edits from end users that manipulate the visual appearance or other characteristics of the electronic book. In some instances, the editing module 230 may cooperate with the user interface module 205 to generate editing interfaces that include tools that allow end users to modify an electronic book. More specifically, the rendering engine 220 may render a view of a selected page of an electronic book which is displayed via an editing interface such as shown in FIGS. 3A-3H. As a page (or an asset within a page) is modified, the rendering module 230 may continually generate views of the electronic document such that end users may visually inspect their changes. That is, modifications may be viewed in near real time as the electronic book is modified.

End users may utilize the tools to modify the page of the electronic book, or individual assets within the page. End users may insert, modify, or delete assets within a page. Non-limiting examples of some contemplated assets include pop-up windows, images, text, and word definitions. Other assets may include a panel-by-panel viewer (e.g., for comic books and other panel-based books) including a function for jumping to a specific frame. Additional assets may include navigation menus, scrollable with thumbnails, links, hyperlinks, along with “style-switching” that allows the end user to change the appearance/layout of an electronic book in accordance with user preferences.

Other types of assets may include animations (e.g., touch-based and auto-play) along with “reveals” where the reader lifts a cover/flap on the page, such as with physical board books.

Other assets such as audio (also combined/incorporated into popups and panels, “talking photos” that speak a caption) and cross-promotion/purchasing of songs. Additionally, video assets, which may be combined/incorporated into popups and panels, 3D images and simulated 3D images, which may be interactive (e.g., reacts to touch-based events) or automatically displayed, are also contemplated. Touch-based events like tapping to hear audio/video played and interactive 3D widgets.

Assets may also include surveying or educational applications. For example, self-check quizzes (where answers are revealed on click), test quizzes (correct/incorrect notice displayed upon selection), final quizzes where a reader can fill out text and email to an instructor or communicated to a Learning Management System (LMS), flash cards that utilize random/ordered terms or definitions.

Gaming assets may also be included such as crossword puzzles and Sudoku, including a method of sending a “recovery code” to oneself to restore the puzzle to a previous state. Collaborative crossword puzzles with a friend or communication of invitations challenging other readers to participate, integrated social media feeds specific to the subject matter of the book (with options of filtering by classmate and/or school), integration with micro-blogging services to share parts of an electronic book, crowd-source writing, where multiple authors collaborate on an electronic book in real time (also contemplating readers that read in real time. In these instances, the electronic book may be “locked” for editing to readers, but not to “authors.”

Other features may include multilingual translation that may be facilitated by a menu item that toggles to transform a book from one language into another (or a section). The electronic book may also include a “choose your own adventure” feature (e.g., interactive fiction), where the electronic book presents a reader with a series of options/choices in the story and based on their choice, they jump to another part of the book (multiple story threads based on user choice).

The electronic book may also include a built-in dictionary to replace or enhance an existing dictionary system, enable auto-location of terms in the book and underline those contained in the database.

The electronic book may also include specific pages that are printable in a book for accompanying activities (e.g. something a child needs to print out and cut/glue according to instructions or a paper plane book), a photo frame feature that is initiated by turning on a switch that changes the device into digital photo frame and displays all the images in the book in random/sequential order.

Other contemplated features include content obfuscation, where contents of a book may only become visible/unscrambled when a password is entered either for the whole book or on a page-by-page basis. Finger painting and/or coloring, where a reader may use a finger as a brush to fill color in of a coloring page. Books may also comprise drag and drop jigsaw puzzles where readers may drag pieces from a pile into place to complete the picture, along with direct chat or personal communications media (e.g. telephonic or VOIP features) for support, assistance, or instant discussion of the book/page contents with author or fans.

It will be understood that in some instances assets may be incorporated in the form of a JavaScript or other similar macro, applet, program, widget, and the like.

When an asset is inserted into an electronic book, the editing module 230 may review the attributes of the asset to determine if there are any potential conflicts between the asset and the electronic book standard that is utilized to generate the electronic book. If the editing module 230 detects a conflict, the editing module 230 may alert the end user by generating and displaying a conflict message via a user interface. In some instances, the editing module 230 may automatically adjust one or more of the attributes of an asset that has been determined to cause a conflict.

By way of non-limiting example, if an asset such as a video file is inserted, and the format of the video file cannot be played by the display device that utilizes the electronic book standard, then the user may be prompted to replace the video file with a compatible version. In other embodiments, the editing module 230 may automatically convert the video file into a suitable file format.

In addition to inserting assets, the editing module 230 may allow end users to modify attributes of individual assets, reposition the assets within a page, or delete the asset entirely.

After modifications have been made to the electronic book, the rendering module 230 may verify the electronic book files (e.g. the CSS, XML, XHTML, etc.) to ensure that the instructions included in the files follow appropriate semantic conventions, that pages have correct suffixes, titles, tags, and so forth. Additionally, CSS files may be validated via a suitable validator.

The structure of the final electronic book file may also be verified. For example, the metadata file, file manifest, file spine, file guide, or other portions of the book may be verified. Assets may also be verified individually, such as video files, audio files, and the like.

In some instances, once an electronic book has been generated, the re-rendering module 235 may be executed to transform an electronic book that was generated according to a first electronic book standard into an electronic book generated according to a second electronic book standard. Advantageously, the re-rendering module 235 may determine characteristics from content of the first electronic book, the characteristics at least defining a layout of the content that defines how the content of the first electronic book is displayed. Once the characteristics have been determined, the re-rendering module 235 may transform the content into the second electronic book according to the second electronic book standard.

It will be understood that conflicts may arise during the conversion process due to discrepancies between electronic book standards, and therefore, the re-rendering module 235 may be configured to detect these conflicts, provide error messages indicative of the conflicts, and in some instances, automatically resolve the conflict, as was described in greater detail with reference to the editing module.

FIGS. 3A-H illustrate various user interfaces that are generated by the user interface module described above. Each of the various user interfaces will be described briefly below. FIG. 3A illustrates an exemplary user interface (hereinafter “UI”). The UI 300 shows a single page of an electronic document along with an information pane that includes characteristics of the electronic book. Additionally, an “add new item” menu is also displayed.

FIG. 3B illustrates another UI 305 that includes a book options menu that allows end users to modify fixed layout dimensions of the displayed page, along with footer information, table of contents, and page order information.

FIG. 3C illustrates another exemplary UI 310 showing a listing of a table of contents for the electronic book, along with an edit button that allows for editing of the table of contents.

FIG. 3D illustrates yet another exemplary UI 315 that shows additional page options. Options for a selected asset may be modified via dropdown menus such as CSS Element, Font, HTML Element, Color, Font Type/Status, and the like.

FIG. 3E illustrates an additional exemplary UI 320 that includes link options for editing links included in the page. It is noteworthy that the term edit, as utilized throughout may include, but is not limited to, adding, deleting, modifying, replacing, and so forth. For example, link attributes may be selected via dropdown menus such as Link Type, URL, Title, and the like.

FIG. 3F illustrates an additional exemplary UI 325 that includes media options for editing media files included in the page. For example, media options for an image file may be selected via input mechanisms such as Dimensions boxes, Position boxes, and the like. Other types of assets may have selectable or definable attributes that may be specified by the use of other tools.

FIG. 3G illustrates an additional exemplary UI 330 that includes a mechanism such as a button that allows textual content (such as a selected segment of text) included in the page to be interpreted via optical character recognition.

FIG. 3H illustrates an additional exemplary UI 335 that allows end users to edit the title of the currently displayed page, along with a dropdown menu that allows for selection of a background image within the page.

FIG. 3I illustrates an additional exemplary UI 340 that allows end users to add rich feature such as an educational feature. More specifically, the UI 340 includes a pop-up window that provides an end user with a plurality of input mechanisms that allow the end user to specify questions that may be asked of readers when they read the electronic book. End users may also be allowed to specify responses that will be provided in the event that the reader chooses a correct or incorrect answer.

FIG. 3J illustrates an additional exemplary UI 345 that allows end users to add additional rich features via a smart widget panel. In some instances the smart widget panel may allow end users to insert different types of assets such as paneling (e.g., similar to paneling within a comic book), 3D images or animations, communications features (e.g., email, SMS, telephonic, peer-to-peer, and so forth), a dictionary, an animation, a quiz, a crossword puzzle, a Sudoku puzzle, flash cards, a jigsaw puzzle, and other types of rich features. In some instances, rich features, such as the jigsaw puzzle may take images or other assets within the electronic book and convert/transform them into other types of content. For example, a jigsaw puzzle may be created from an image within the electronic book.

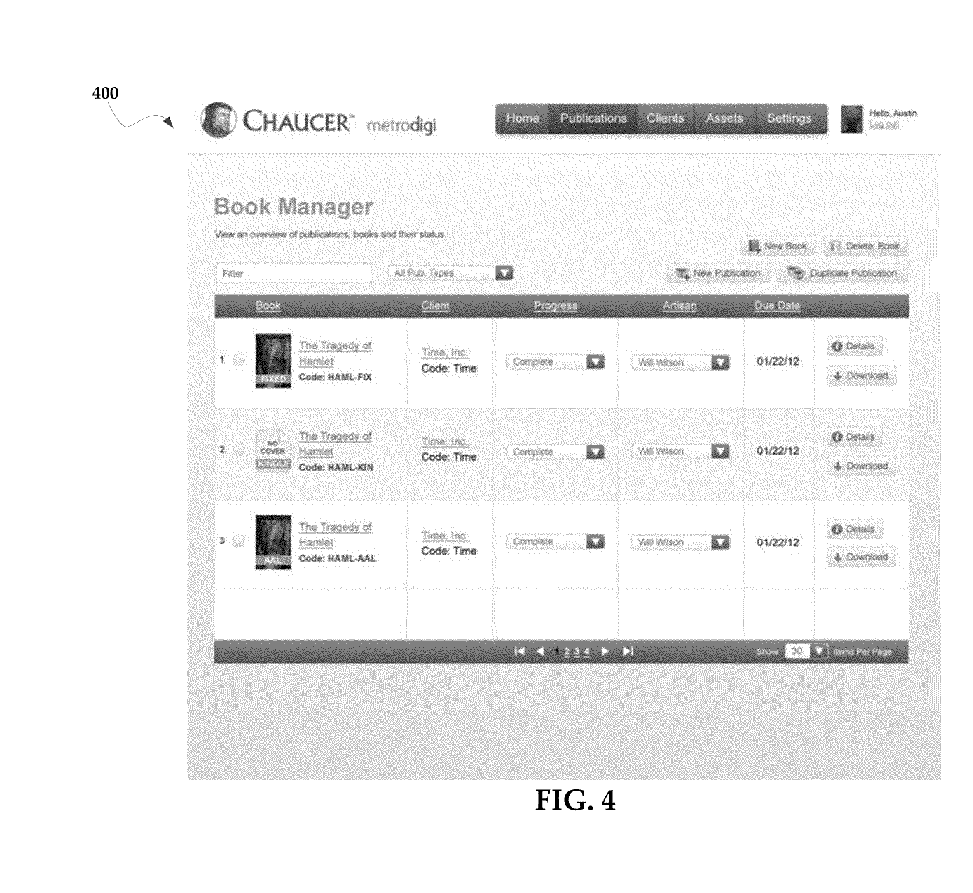

FIG. 4 illustrates an exemplary user interface 400 such as a book manager page. The manager page allows end users to view an overview of their publications, books, and their relative statuses. The manager shows the book “The Tragedy of Hamlet” that has been converted into three separate electronic books, according to different electronic book standards (e.g., FIX, KIN, AAL, etc.).

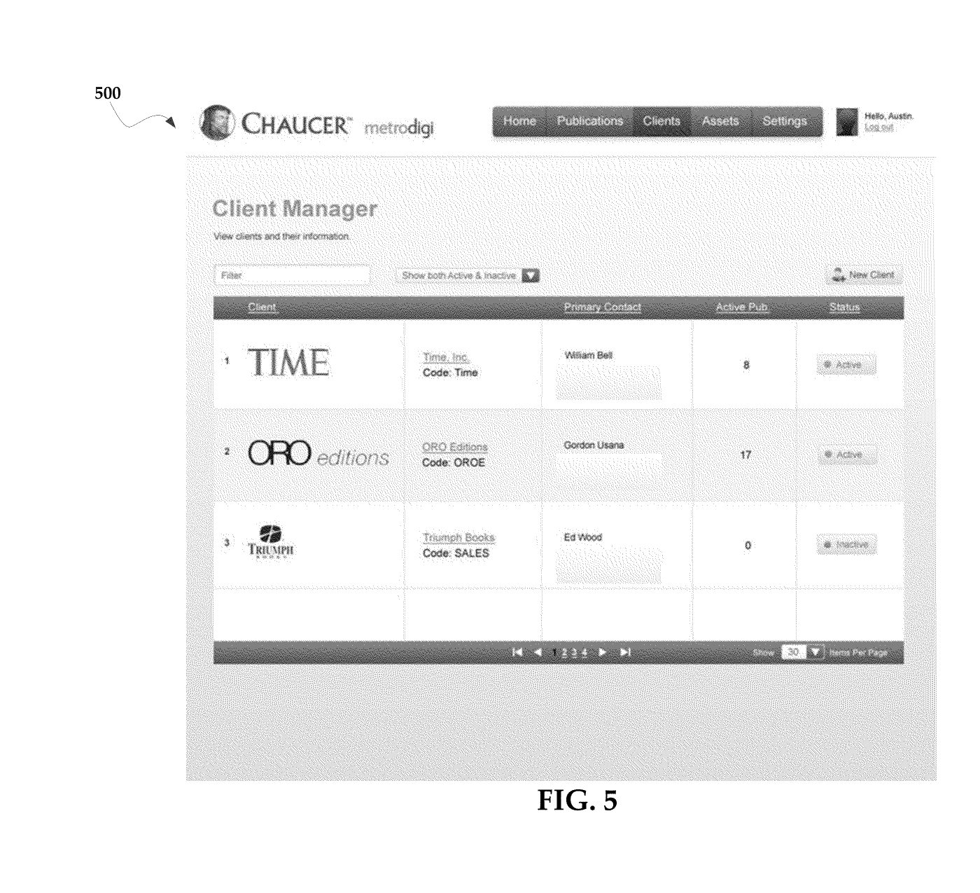

FIG. 5 illustrates an exemplary user interface 500, such as a client manager page. The client manager page includes a numeric list of clients along with contact information for each client.

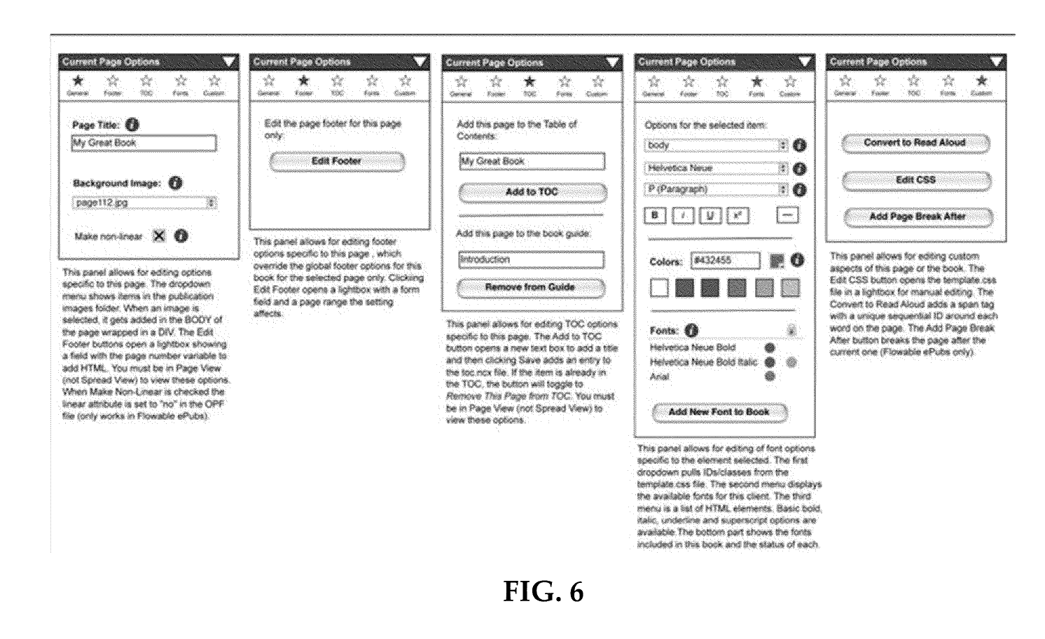

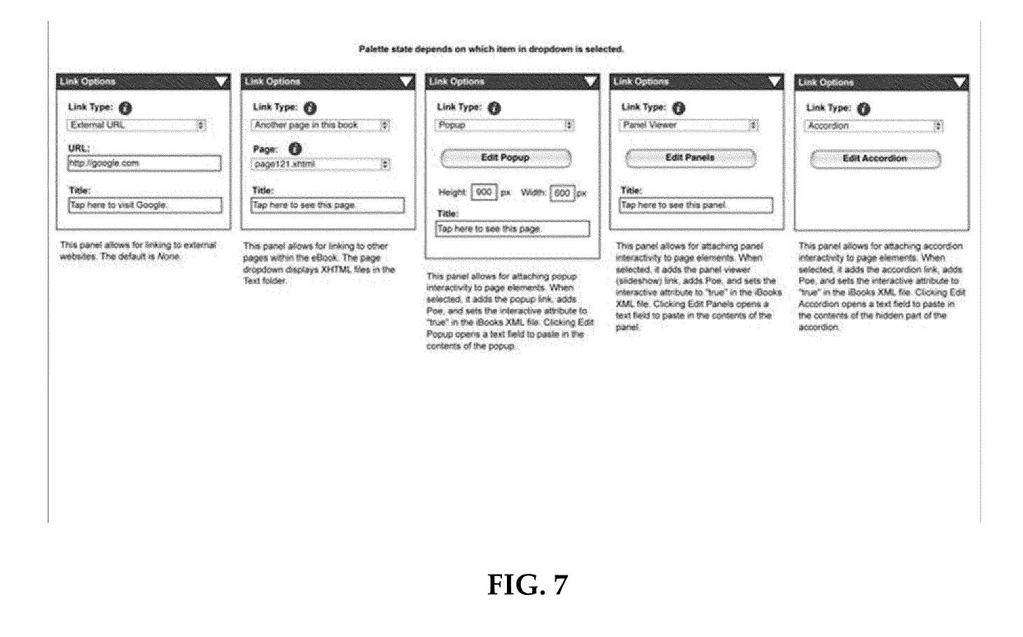

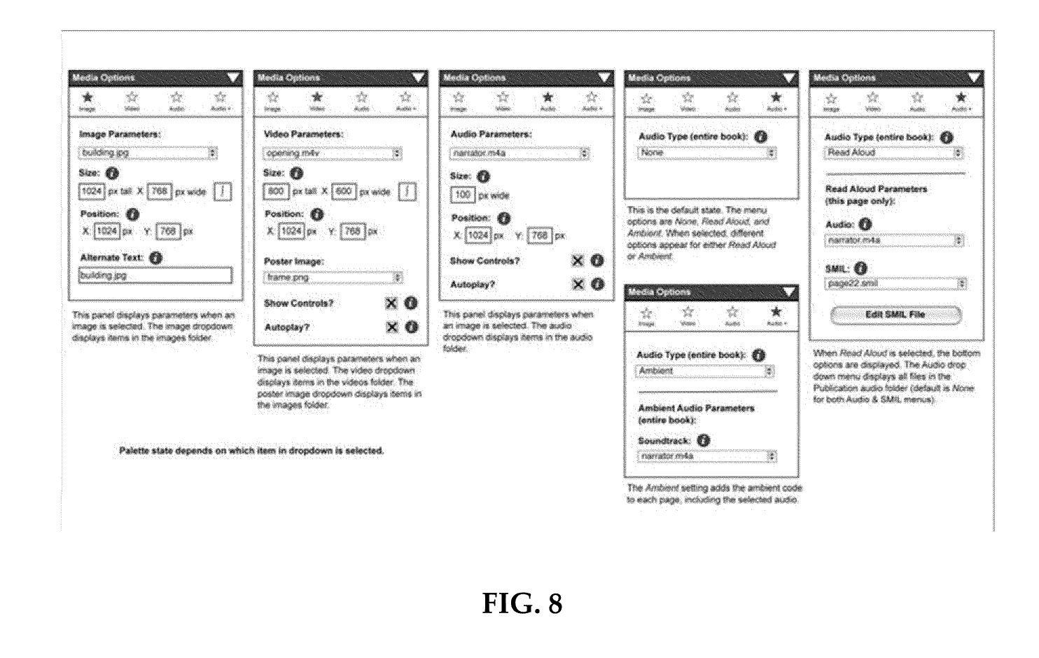

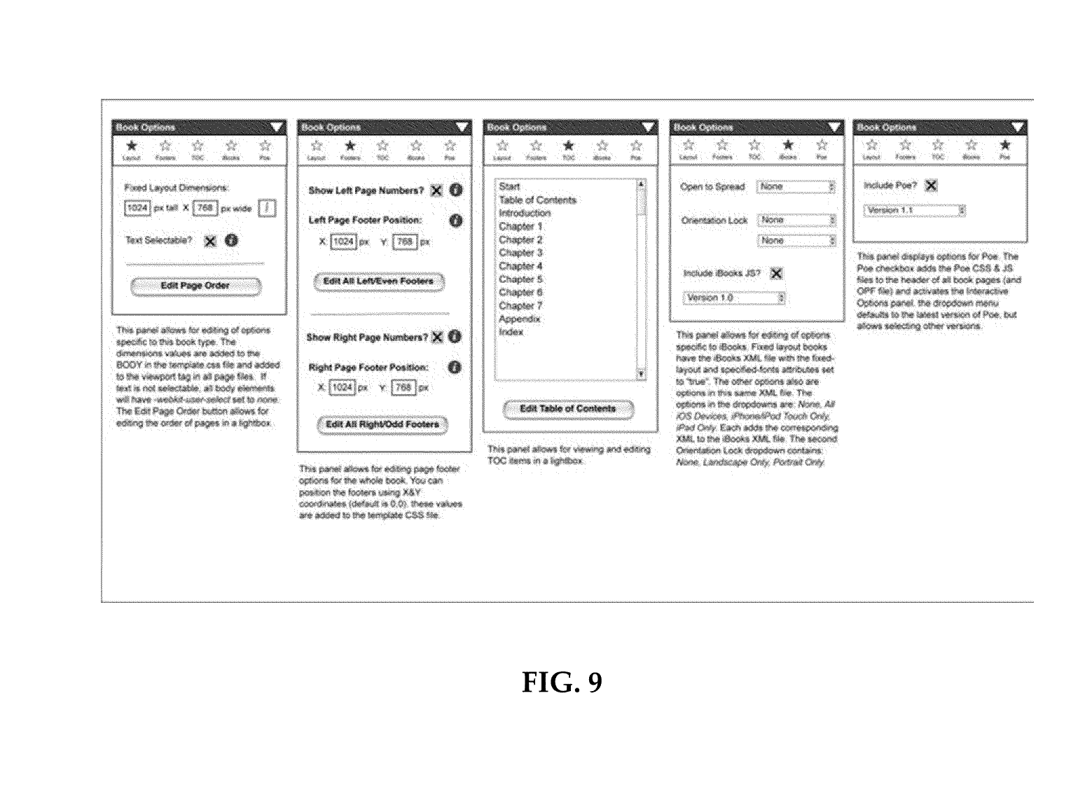

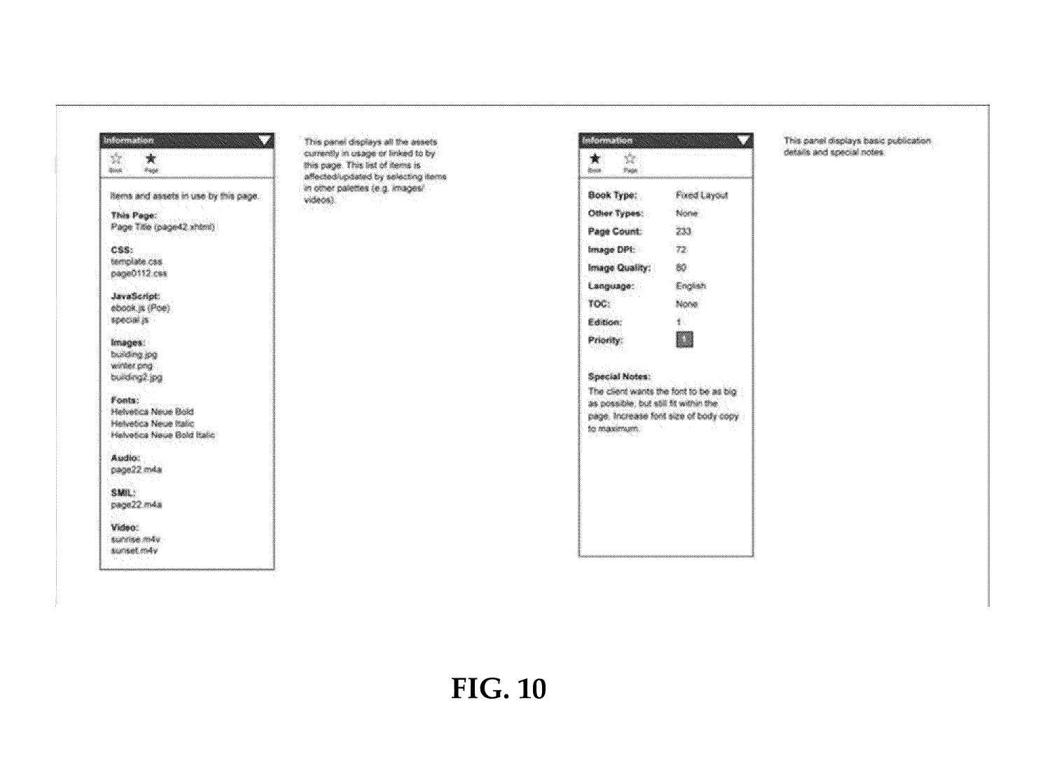

FIG. 6 illustrates a plurality of current page option panels that may be utilized by end users to modify pages of their electronic books. FIG. 7 illustrates a plurality of links option panels that may be utilized by end users to modify links included in pages of their electronic books. FIG. 8 illustrates a plurality of media option panels that may be utilized by end users to modify media included in pages of their electronic books. FIG. 9 illustrates a plurality of book option panels that may be utilized by end users to modify book characteristics of their electronic books. FIG. 10 illustrates a pair of information panels that display assets that are currently in use or linked by a particular page, along with publication details and special notes associated with the page.

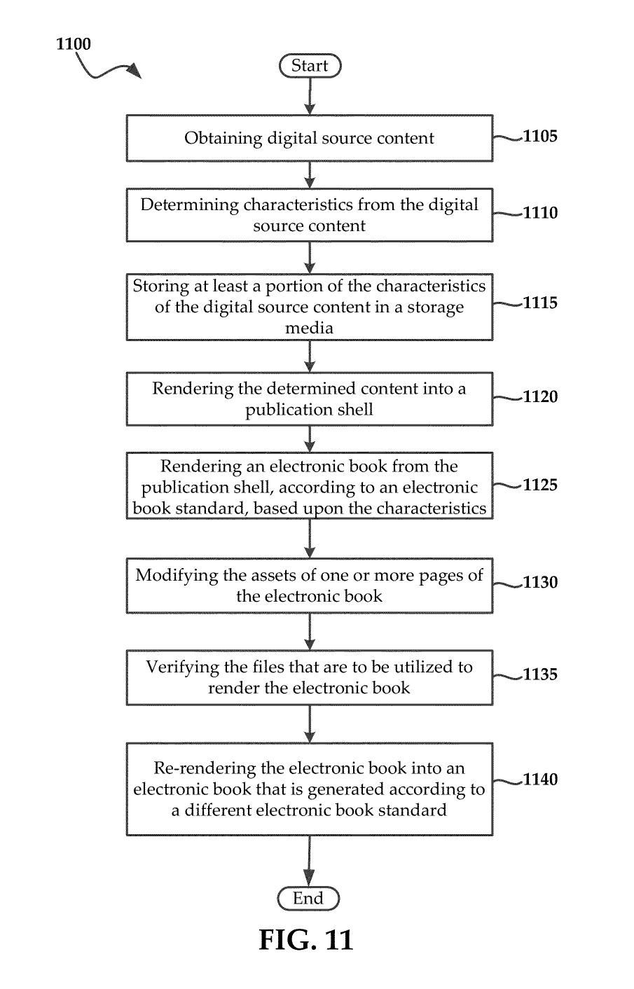

FIG. 11 is a flowchart of an exemplary method 1100 for generating an electronic book according to an electronic book standard. The method may include a step 1105 of obtaining digital source content. It will be understood that in some embodiments, the step 1105 may include receiving digital source content via a user interface. It is noteworthy to mention that the digital source content may be arranged in a native format that determines how the digital source content is displayed on a user interface. That is, the native format of the digital source content may define how the digital source content appears to the end user viewing the content via a display device.

Next, the method may include a step 1110 of determining characteristics from the digital source content. The characteristics that are extracted at least define a layout of the digital source content in the native format. In other instances assets of the content may be determined, along with attributes of each asset and a position of each asset on a page of the content

The method may include a step 1115 of storing at least a portion of the characteristics of the digital source content in a storage media before a step 1120 of rendering the determined content into a publication shell. The method may also include a step 1125 of rendering an electronic book from the publication shell, according to an electronic book standard, based upon the characteristics. It will be understood that the rendering step may produce an electronic book that has a generated format that substantially corresponds to the native format of the digital source content.

In some embodiments, the method may include an optional step 1130 of modifying the assets of one or more pages of the electronic book. In some instances, the method may include a step 1135 of verifying the files that are to be utilized to render the electronic book and/or an optional step 1140 of re-rendering the electronic book into an electronic book that is generated according to a different electronic book standard. It will be understood that the method may include additional or fewer steps than those describe above, also the steps may be executed in any order desired.

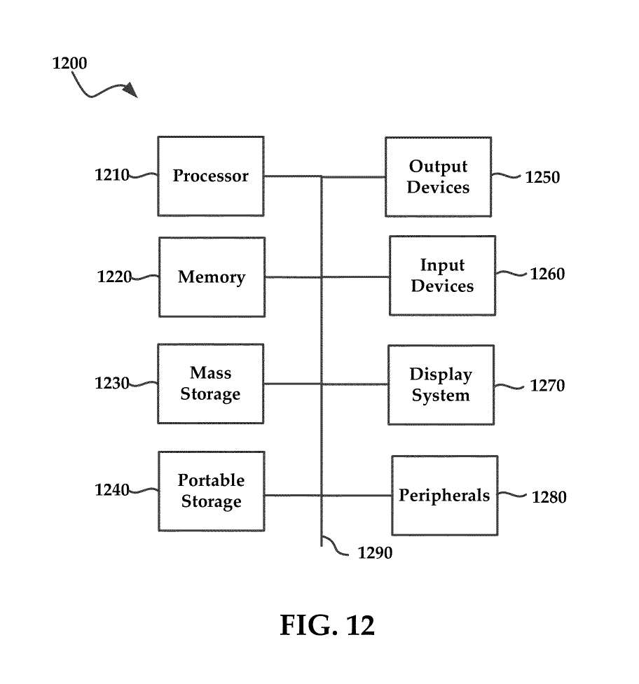

FIG. 12 illustrates an exemplary computing system 1200 that may be used to implement an embodiment of the present technology. The system 1200 of FIG. 12 may be implemented in the contexts of the likes of conversion system 105 (FIG. 1). The computing system 1200 of FIG. 12 includes one or more processor units 1210 and main memory 1220. Main memory 1220 stores, in part, instructions and data for execution by processor unit 1210. Main memory 1220 may store the executable code when in operation. The system 1200 of FIG. 12 further includes a mass storage device 1230, portable storage device(s) 1240, output devices 1250, input devices 1260, a display system 1270, and peripherals 1280.

The components shown in FIG. 12 are depicted as being connected via a single bus 1290. The components may be connected through one or more data transport means. Processor unit 1210 and main memory 1220 may be connected via a local microprocessor bus, and the mass storage device 1230, peripheral device(s) 1280, portable storage device 1240, and display system 1270 may be connected via one or more input/output (I/O) buses.

Mass storage device 1230, which may be implemented with a magnetic disk drive or an optical disk drive, is a non-volatile storage device for storing data and instructions for use by processor unit 1210. Mass storage device 1230 may store the system software for implementing embodiments of the present technology for purposes of loading that software into main memory 1220.

Portable storage device 1240 operates in conjunction with a portable non-volatile storage medium, such as a floppy disk, compact disk, digital video disc, or USB storage device, to input and output data and code to and from the computer system 1200 of FIG. 12. The system software for implementing embodiments of the present technology may be stored on such a portable medium and input to the computer system 1200 via the portable storage device 1240.

Input devices 1260 provide a portion of a user interface. Input devices 1260 may include an alphanumeric keypad, such as a keyboard, for inputting alpha-numeric and other information, or a pointing device, such as a mouse, a trackball, stylus, or cursor direction keys. Additionally, the system 1200 as shown in FIG. 12 includes output devices 1250. Suitable output devices include speakers, printers, network interfaces, and monitors.

Display system 1270 may include a liquid crystal display (LCD) or other suitable display device. Display system 1270 receives textual and graphical information, and processes the information for output to the display device.

Peripherals 1280 may include any type of computer support device to add additional functionality to the computer system. Peripheral device(s) 1280 may include a modem or a router.

The components provided in the computer system 1200 of FIG. 12 are those typically found in computer systems that may be suitable for use with embodiments of the present invention and are intended to represent a broad category of such computer components that are well known in the art. Thus, the computer system 1200 of FIG. 12 may be a personal computer, hand held computing device, telephone, mobile computing device, workstation, server, minicomputer, mainframe computer, or any other computing device. The computer may also include different bus configurations, networked platforms, multi-processor platforms, etc. Various operating systems may be used including Unix, Linux, Windows, Macintosh OS, Palm OS, Android, iPhone OS and other suitable operating systems.

It is noteworthy that any hardware platform suitable for performing the processing described herein is suitable for use with the technology. Computer-readable storage media refer to any medium or media that participate in providing instructions to a central processing unit (CPU), a processor, a microcontroller, or the like. Such media may take forms including, but not limited to, non-volatile and volatile media such as optical or magnetic disks and dynamic memory, respectively. Common forms of computer-readable storage media include a floppy disk, a flexible disk, a hard disk, magnetic tape, any other magnetic storage medium, a CD-ROM disk, digital video disk (DVD), any other optical storage medium, RAM, PROM, EPROM, a FLASHEPROM, any other memory chip or cartridge.

While various embodiments have been described above, it should be understood that they have been presented by way of example only, and not limitation. The descriptions are not intended to limit the scope of the technology to the particular forms set forth herein. Thus, the breadth and scope of a preferred embodiment should not be limited by any of the above-described exemplary embodiments. It should be understood that the above description is illustrative and not restrictive. To the contrary, the present descriptions are intended to cover such alternatives, modifications, and equivalents as may be included within the spirit and scope of the technology as defined by the appended claims and otherwise appreciated by one of ordinary skill in the art. The scope of the technology should, therefore, be determined not with reference to the above description, but instead should be determined with reference to the appended claims along with their full scope of equivalent

What is claimed is:

1. A method for generating an electronic book according to an electronic book standard, comprising:
obtaining digital source content, the digital source content being arranged in a native format, the native format determining how the digital source content is displayed on a user interface;
determining characteristics from the digital source content, the characteristics at least defining a layout of the digital source content in the native format; and
rendering the determined content into an electronic book according to an electronic book standard, based upon the characteristics such that a generated format of the electronic book substantially corresponds to the native format of the digital source content.

2. The method according to claim 1, wherein the characteristics include a location and one or more attributes for each asset on each page of the digital source content.

3. The method according to claim 1, further comprising extracting the characteristics of the digital source content and storing at least a portion of the characteristics in a database.

4. The method according to claim 1, further comprising storing the electronic book in a content repository.

5. The method according to claim 1, further comprising outputting the electronic book in the generated format via a graphical user interface, the electronic book being presented via the graphical user interface in such a way that at least a portion of the content of the electronic book is editable.

6. The method according to claim 1, further comprising inserting an asset into the electronic book.

7. The method according to claim 6, wherein the asset includes any of a pop-up window comprising content, an interactive link, a video file, an audio file, an image file, an animation, a table of contents, a bibliography, an embedded file, an educational widget, a social media object, and combinations thereof.

8. The method according to claim 6, wherein the asset includes one or more attributes, wherein the asset is inserted into the electronic book according to the electronic book standard and the one or more attributes.

9. The method according to claim 8, further comprising:
determining a potential conflict between the asset and the electronic book standard, the potential conflict being determined by comparing the one or more attributes of the asset to the electronic book standard; and
providing a conflict message indicative of the potential conflict via a graphical user interface.

10. The method according to claim 1, further comprising automatically selecting an electronic book standard by comparing attributes of assets of the digital source content to a plurality of electronic book standards and selecting an electronic book standard based upon the comparison.

11. A method for transforming a first electronic book that was generated according to a first electronic book type into a second electronic book according to a second electronic book type, the method comprising:
determining characteristics from content of the first electronic book, the characteristics at least defining a layout of the content that defines how the content of the first electronic book is displayed; and
transforming content into the second electronic book according to the second electronic book type.

12. The method according to claim 11, further comprising re-rendering the electronic book that was generated according to a first electronic book type into a plurality of electronic books, wherein each of the electronic books is generated according to a unique electronic book type relative to other electronic books that are generated.

13. A system for generating an electronic book according to the electronic book standard, comprising:
a memory for storing executable instructions;
a processor for executing the instructions stored in memory;
an input module stored in memory and executable by the processor to obtain digital source content, the digital source content being arranged in a native format, the native format determining how the digital source content is displayed on a user interface;
a parsing module stored in memory and executable by the processor to determine characteristics from the digital source content, the characteristics at least defining the layout of the digital source content in the native format; and
a rendering engine stored in memory and executable by the processor to render the determined content into an electronic book according to the electronic book standard, based upon the characteristics such that a generated format of the electronic book substantially corresponds to the native format of the digital source content.

14. The system according to claim 13, wherein the characteristics include locations and formats of objects on each page of the digital source content.

15. The system according to claim 13, wherein the parsing module extracts the characteristics of the digital source content.

16. The system according to claim 15, further comprising a storage module that is stored in memory and executable by the processor to store at least a portion of the characteristics in a database.

17. A system for editing an electronic book that is being generated according to the electronic book standard, comprising:
a memory for storing executable instructions;
a processor for executing the instructions stored in memory;
an editing module stored in memory and executable by the processor to manage assets for the electronic book, the assets being included in the electronic book according to the electronic book standard; and
wherein an asset includes one or more attributes and the asset is inserted into the electronic book by the editing module according to the electronic book standard and the one or more attributes.

18. The system according to claim 17, further comprising a user interface module that renders a graphical user interface that comprises a visual representation of the electronic book in the generated format.

19. The system according to claim 18, wherein the editing module further provides editing tools via the graphical user interface that allow at least a portion of the content of the rendered electronic book to be edited while the graphical user interface is updated to reflect edits to the electronic book as the edits are received.

20. The system according to claim 17, wherein an asset includes any of a pop-up window comprising content, an interactive link, a video file, an audio file, an image file, an animation, a table of contents, a bibliography, an embedded file, an educational widget, a social media object, a puzzle, a three dimensional object, communications medium, and combinations thereof.

21. The system according to claim 17, wherein the editing module further:
determines a potential conflict between the asset and the electronic book standard, the potential conflict being determined by comparing the one or more attributes of the asset to the electronic book standard; and
provides a conflict message indicative of the potential conflict via the graphical user interface.

22. The system according to claim 21, wherein the editing module further automatically updates one or more of the attributes of the asset based upon the comparison of one or more attributes of the asset to the electronic book standard to resolve the conflict.

23. The system according to claim 17, further comprising a re-rendering module that transforms an electronic book that was generated according to a first electronic book standard into an electronic book generated according to a second electronic book standard, wherein the re-rendering module determines characteristics from content of the first electronic book, the characteristics at least defining a layout of the content that defines how the content of the first electronic book is displayed; and transforms content into the second electronic book according to the second electronic book standard.

24. A non-transitory computer readable storage media having a program embodied thereon, the program being executable by a processor to perform a method for generating an electronic book according to the electronic book standard, the method comprising:
obtaining digital source content, the digital source content being arranged in a native format, the native format determining how the digital source content is displayed on a user interface;
determining characteristics from the digital source content, the characteristics at least defining a layout of the digital source content; and
rendering the determined content into an electronic book according to an electronic book standard, based upon the characteristics such that a generated format of the electronic book substantially corresponds to the native format of the digital source content.

25. The computer readable storage media according to claim 24, further comprising generating a view of the electronic book that is different from a view of the electronic book rendered by a display device that operates according to the electronic book standard utilized to render the electronic book.
